(19) United States
(12) Patent Application Publication
(10) Pub. No.: US 2014/0307581 A1
(43) Pub. Date: Oct. 16, 2014

(54) DEVICE AND METHOD OF COMMUNICATING, AND COMPUTER READABLE MEDIUM FOR COMMUNICATING

(71) Applicant: Kabushiki Kaisha Toshiba, Minato-ku (JP)

(72) Inventors: Seijiro YONEYAMA, Yokohama-shi (JP); Yoshihiro Oba, Kawasaki-shi (JP)

(73) Assignee: Kabushiki Kaisha Toshiba, Minato-ku (JP)

(21) Appl. No.: 14/188,937

(22) Filed: Feb. 25, 2014

(30) Foreign Application Priority Data
Apr. 16, 2013 (JP) 2013-085432

(51) Int. Cl. H04L 12/931; H04W 72/00

(52) U.S. Cl. CPC H04L 49/201; H04W 72/005
USPC 370/254; 370/312

(57) ABSTRACT

A communication device according to an embodiment may be connected with other communication device via a multihop meshed network. The device comprises a transmission unit and a decision unit. The transmission unit may be configured to transmit packet to the other communication device by either one of a unicast communication and a multicast communication. The decision unit may be configured to decide between the unicast communication and the multicast communication as a sending method of multicast packet to be transmitted form the transmission unit based on configuration information about the multihop meshed network.

CROSS-REFERENCE TO RELATED APPLICATION(S)

This application is based upon and claims the benefit of priority from the Japanese Patent Application No. 2013-085432, filed on Apr. 16, 2013; the entire contents of which are incorporated herein by reference.

### FIELD

Embodiments described herein relate generally to a device and a method of communicating, and a computer-readable medium for communicating.

### BACKGROUND

Conventionally, there is a technology for multicasting in a multihop meshed network. Reference 1 of IETF RFC6550., RPL: IPv6 Routing Protocol for Low-Power and Lossy Networks (Proposed standard, 2012), which is a non-patent literature, is a technical specification of the Rooting Protocol for Low-Power and Lossy Networks (RPL) for multihop meshed network formulated by the Internet Engineering Task Force (IETF). Reference 2 of IETF I.D., draft-ietf-trickle-mcast-03, “Multicast Protocol for Low power and Lossy Networks (MPL)”, Jan. 24, 2013, which is a non-patent literature, is another technical specification with different technology for multicast communication on RPL.

### BRIEF DESCRIPTION OF THE DRAWINGS

FIG. 1 is a conceptual diagram showing a configuration example of a communication system according to an embodiment;

FIG. 2 is a block diagram showing a configuration example of a node according to the embodiment;

FIG. 3 is a flow chart showing an operation example of communication control executed on each node in the embodiment;

FIG. 4 is a schematic view showing a configuration example of a communication system according to a first example of the embodiment;

FIG. 5 is an illustration showing an example of a routing table for IP unicast stored on each node shown in FIG. 4;

FIG. 6 is an illustration showing an example of a routing table for IP multicast stored on each node shown in FIG. 4;

FIG. 7 is a schematic view showing a configuration example of a communication system according to a second example of the embodiment;

FIG. 8 is an illustration showing an example of a routing table for IP multicast stored on each node shown in FIG. 7;

FIG. 9 is a schematic view showing a configuration example of a communication system according to a third example of the embodiment; and

FIG. 10 is an illustration showing an example of a routing table for IP multicast stored on each node shown in FIG. 9.

### DETAILED DESCRIPTION

Exemplary embodiments of a device and a method of communicating, and a computer-readable medium for communicating will be explained below in detail with reference to the accompanying drawings.

The following embodiment describes a communication apparatus connected with another communication apparatus via a multihop meshed network and executing IP layer multicast communication. The communication apparatus according to the embodiment has one feature of dynamically controlling communication methods in a MAC-layer broadcast communication and a MAC-layer unicast communication based on configuration information about the multihop meshed network.

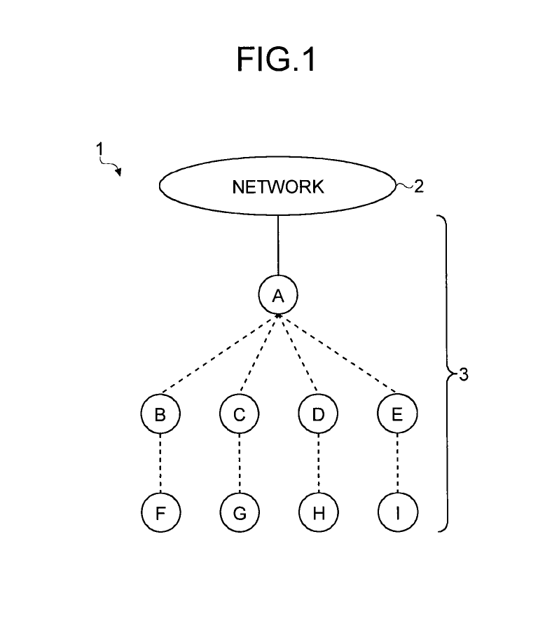

FIG. 1 is a conceptual diagram showing a configuration example of a communication system according to the embodiment. In FIG. 1, a communication system 1 including a plurality of wireless stations (hereinafter to be referred to as nodes) A to I constructing a multihop meshed network 3 is shown; the multihop meshed network being connected to a network 2. The communication network 1 can be various types of communication networks such as a smart grid, the Ethernet©, or the like.

In FIG. 1, broken lines connecting between the nodes A to I are wireless links, and indicates radio wave ranges of the nodes A to I, respectively. Therefore, between the nodes A to I connected by each broken line, wireless communication channels are established, respectively. However, it is not limited to such configuration, it is also possible to connect between the nodes A to I via wired links. In addition, a solid line connecting between the network 2 and the node A can be either a wireless link or a wired link. In the following, when each node A to I is not distinguished one another, they will be explained as a node 10.

For instance, radio wave ranges of the node A are the nodes B, C and D. Therefore, the node A can communicate with the nodes B, C and D, respectively. In FIG. 1, although an example in which the multihop meshed network 3 is created with seven nodes is shown, it is also possible to create the multihop meshed network 3 with nine or more nodes.

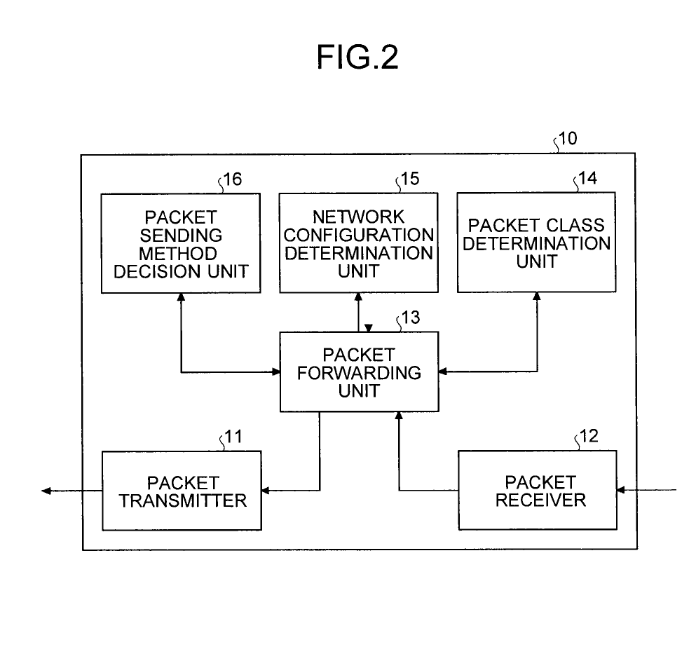

FIG. 2 is a block diagram showing a configuration example of a node according to the embodiment. As shown in FIG. 2, the node 10 according to the embodiment has a packet transmitter 11 for transmitting a packet to the wireless link, a packet receiver 12 for receiving a packet from the wireless link, a packet forwarding unit 13 for forwarding a packet received by the packet receiver 12 to the packet transmitter 11, a packet class determination unit 14 for determining whether a packet to be processed by the packet forwarding unit 13 is an IP multicast packet being subject to controlling or not, a network configuration determination unit 15 for determining network configuration information of the multihop meshed network 3 (hereinafter to be referred to as multihop meshed network configuration information), and a packet sending method decision unit 16 for deciding a sending method of packet based on a determination result of the packet class determination unit 14 and the network configuration determination unit 15.

In FIG. 2, although the packet transmitter 11, the packet receiver 12, the packet forwarding unit 13, the packet class determination unit 14, the network configuration determination unit 15 and the packet sending method decision unit 16 are configured as hardware, it is not limited to such configuration, and it is also possible that at least one or all of them are configured as software. Furthermore, in the embodiment, although a case where the standard of the IP layer is IPv6 (IETF RFC2460) and the standard of the MAC layer is IEEE 802.15.4 is explained as an example, it is not limited to such arrangement, and it is also possible to employ another standards such as IPv4 (IETF TFC791), IEEE 802.11, or the like, on the IP layer and the MAC layer.

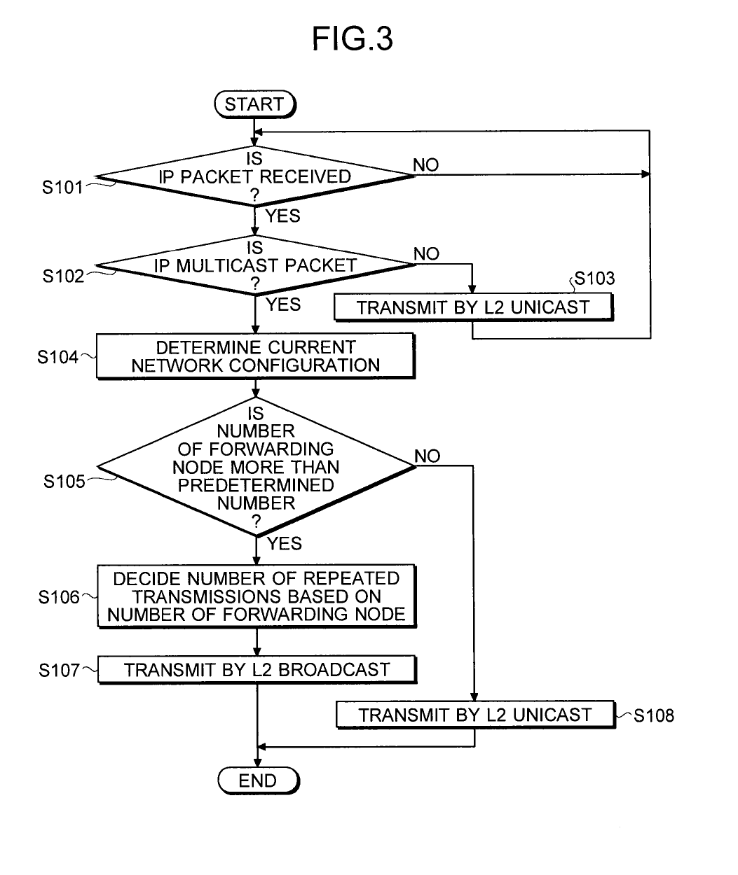

Next, an operation of each node 10 will be described in detail with reference to the accompanying drawings. FIG. 3 is a flow chart showing an example of communication control operation executed by each node in the embodiment. In the following explanation, an operation of the packet forwarding unit 13 is focused on.

As shown in FIG. 3, firstly, the packet forwarding unit 13 waits until the packet receiver 12 receives IP packet from a node with which wireless link is established among the nodes on the network 2 and the other nodes A to I on the multihop meshed network 3 (step S101). When the IP packet is received (step S101; YES), the packet forwarding unit 13 determines whether the received IP packet is IP multicast packet to be forwarded or not by using the packet class determination unit 14 (step S102). When the received IP packet is not IP multicast packet (step S102; NO), the packet forwarding unit 13 forwards the received IP packet from the packet transmitter 11 to a forwarding address by unicast (step S103), and then, returns to step S101. On the other hand, when the received IP packet is IP multicast packet (step S102; YES), the packet forwarding unit 13 executes step S104.

Generally, in IP multicast, permission of forwarding is determined based on IP multicast address. When an IP multicast node being a candidate of forwarding destination has a target IP multicast address, the IP multicast packet is forwarded, and when the node has a non-target IP multicast address, the IP multicast packet is not forwarded. As a result, because unnecessary forwarding of IP multicast packet is reduced, it is possible to reduce throughput of the entire network.

In step S104, the packet forwarding unit 13 determines a current network configuration based on the multihop meshed network configuration information using the network configuration determination unit 15. Then, the packet forwarding unit 13 decides a sending method of the IP multicast packet based on the current network configuration determined by the network configuration determination unit 15 by using the packet sending method decision unit 16 (step S105). Specifically, when the number of target nodes of the IP multicast packet in the current network configuration is below two (step S105; NO), the packet forwarding unit 13 decides the MAC-layer unicast communication and executes step S108, and when the number of the target nodes is equal to or more than three (step S105; YES), the packet forwarding unit 13 determines a MAC-layer broadcast communication and executes step S106.

In step S106, the packet forwarding unit 13 determines the number of repeated transmissions of the IP multicast packet based on the number of the target nodes using the packet sending method decision unit 16. The number of repeated transmissions may be calculated as a number which is the number of the forwarding destination nodes being incremented by one. However, the calculation method is not limited to such method, and any alternative method as long as a method for calculating the number of repeated transmissions being capable of achieving high tolerance for packet loss while suppressing too mach increase of throughput of the entire network of the multihop meshed network 3 can be applied.

Next, the packet forwarding unit 13 repeats transmission of the IP multicast packet from the packet transmitter 11 by the MAC-layer broadcast communication according to the the number of repeated transmissions decided by the packet sending decision unit 16 (step S107), and then, finishes this operation or returns to step S101.

For example, when the packet sending decision unit 16 decided the number of repeated transmissions as five in step S106, the packet forwarding unit 13 repeats the transmission of the IP multicast packet from the packet transmitter 11 by the MAC-layer broadcast communication five times. On the other hand, in step S108, the packet forwarding unit 13 transmits the IP multicast packet from the packet transmitter 11 by the MAC-layer unicast communication, and then, finishes this operation or returns to step S101.

By executing such operation, according to the embodiment, in the multihop meshed network 3, it is possible to realize a multicast communication with high reliability while suppressing the consumption of the communication band.

### FIRST EXAMPLE

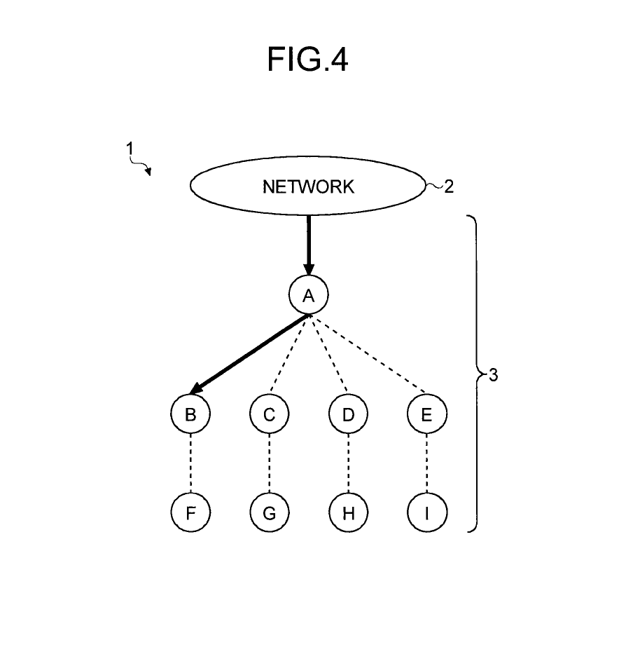

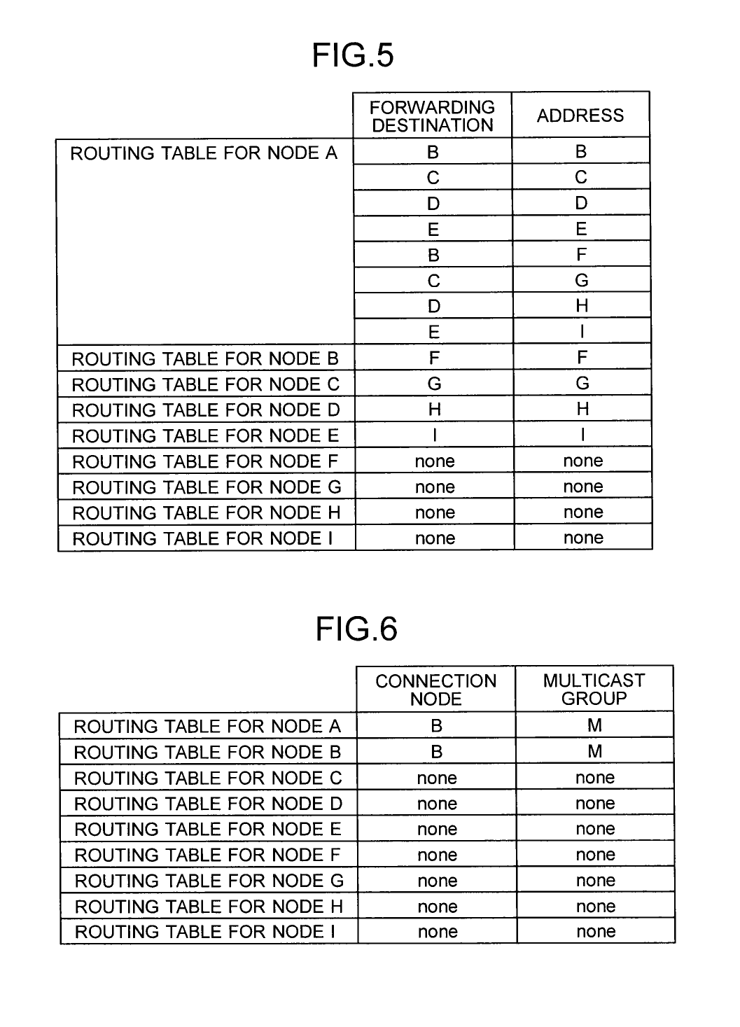

Here, as a first example, a case where the node A forwards IP multicast packet to the node B is explained with reference to the flow chart shown in FIG. 3. FIG. 4 is a schematic view showing a configuration example of a communication system according to the first example. FIG. 5 is an illustration showing an example of a routing table for IP unicast stored on each node shown in FIG. 4. FIG. 6 is an illustration showing an example of a routing table for IP multicast stored on each node shown in FIG. 4.

In FIG. 4, the node B is an IP multicast node capable of receiving IP multicast packet. The other nodes A, C to I are IP unicast nodes not capable of receiving IP multicast packet. Therefore, in FIG. 4, nodes capable of IP unicast communication with the node A are the nodes B, C, D, E, F, G, H and I. With the nodes B, C, D and E, the node A can directly communicate without hopping the other node. On the other hand, with the nodes F, G, H and I, the node A should hop one of the other nodes B to E.

The node A knows that the node B is an IP multicast node based on the Rooting Protocol for Low-Power and Lossy Networks (RPL) for multihop meshed network. For example, in the RPL, each node notices request for logging on the IP multicast communication to the other nodes using a DAO (destination advertisement object) packet. Each node A to I can know presence or absence of IP multicast node thought the use of such behavior. Therefore, in the example shown in FIG. 3, the node A acknowledges that the node B is an IP multicast node. Furthermore, the node A creates each routing tables shown in FIGS. 5 and 6 based on the DAO packet and the request for logging on the IP multicast communication through the use of the DAO packet, and stores them in a predetermined storage.

As shown in FIG. 5, the node A stores a table for assigning a forwarding destination for communicating with the node B, C, D or E with the node B, C, D or E, and a table for assigning a forwarding destination (hereinafter to be referred to as a forwarding destination node) for communicating with the node F, G, H or I (hereinafter to be referred to as a destination node) with the node B, C, D or E. Each of the nodes B, C, D and E stores an IP unicast routing table for forwarding to the destination nodes F, G, H or I. On the other hand, because the node F, G, H and I do not have forwarding destinations, they do not store the IP unicast routing tables.

As shown in FIG. 6, the node A manages that the node B is the IP multicast node for receiving IP packets with a multicast address M. The node B is a multicast node, and controls receipt of IP packets with the multicast address M. The other nodes do not store IP multicast routing tables because there is no multicast node under them and they are not multicast nodes.

In the example shown in FIG. 4, the packet forwarding unit 13 of the node A waits until the packet receiver 12 receives IP packet from a communication device on the network 2 (step S101), and when the packet receiver 12 receives the IP packet (step S101; YES), the packet forwarding unit 13 determines whether the received IP packet is IP multicast packet to be forwarded or not by using the packet class determination unit 14 (step S102). In this example, because it is assumed that the received IP packet is the IP multicast packet, the packet class determination unit 14 determines that the received IP packet is the IP multicast packet (step S102; YES), and executes step S104.

In step S104, the packet forwarding unit 13 of the node A determines a current network configuration based on the multihop meshed network configuration information using the network configuration determination unit 15. Then, the packet forwarding unit 13 of the node A decides a sending method based on the number of the forwarding destination nodes of the IP multicast packet using the packet sending method decision unit 16 (step S105). In the first example, because the number of the forwarding destination nodes is one, the packet sending method decision unit 16 decides the MAC-layer unicast communication (step S105; NO), and executes step S108.

In step S108, the packet forwarding unit 13 of the node A transmits the IP multicast packet from the packet transmitter 11 to the node B by the MAC-layer unicast communication, and then, returns to step S101.

As described above, by employing the MAC-layer unicast communication on the transmission of the IP multicast packet, in the first example, it is possible to realize a communication with high tolerance for packet loss by using resending function of the MAC layer.

### /SECOND EXAMPLE

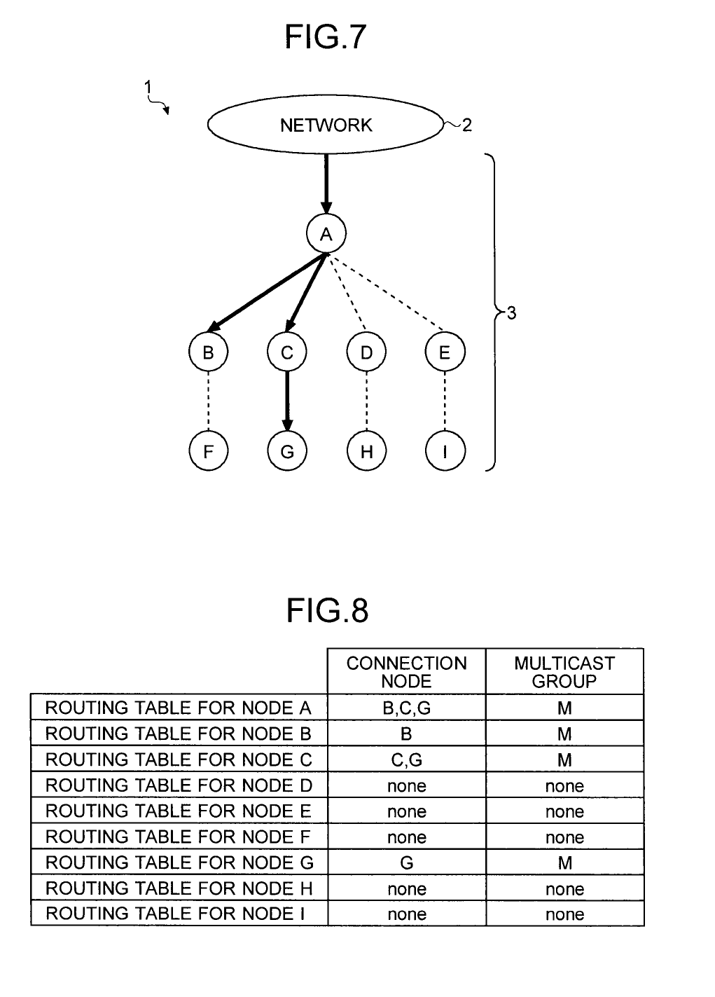

Next, as a second example, a case where the node A forwards IP multicast packet to the nodes B, C, and G is explained with reference to the flow chart shown in FIG. 3. FIG. 7 is a schematic diagram for explaining the second example, and FIG. 8 is an illustration showing an IP multicast routing table stored on each node shown in FIG. 7. As the IP multicast routing table shown in FIG. 6, the routing table is created by each node based on the request for logging on the IP multicast communication using the DAO packet, and is stored on a predetermined storage. An example of the IP unicast routing table stored on each node shown in FIG. 7 may be the same as the table shown in FIG. 5.

In FIG. 7, nodes capable of IP unicast communication with the node A are the nodes B, C, D, E, F, G, H and I. The node A can directly communicate with the node B, C, D and E without hopping the other node. On the other hand, with the nodes F, G, H and I, the node A should hop the other node B, C, D or E.

The nodes B, C and G are IP multicast node capable of receiving IP multicast packet. The node A knows that the nodes B, C and G are IP multicast nodes based on the request for logging on the IP multicast communication using the DAO packet.

As shown in FIG. 8, the node A manages that the nodes B, C and G are the IP multicast nodes for receiving IP packets with a multicast address M. The nodes B and G are multicast nodes, and control receipt of IP packets with the multicast address M, respectively. The node C is a multicast node, controls receipt of IP packets with the multicast address M, and manages that the node G is a multicast node capable of receiving IP packets with the multicast address M. The other nodes do not store IP multicast routing tables because there is no multicast node under them and they are not multicast nodes.

In the example shown in FIG. 7, the packet forwarding unit 13 of the node A waits until the packet receiver 12 receives IP packet from a communication device on the network 2 (step S101), and when the packet receiver 12 receives the IP packet (step S101; YES), the packet forwarding unit 13 determines whether the received IP packet is IP multicast packet to be forwarded or not by using the packet class determination unit 14 (step S102). In this example, because it is assumed that the received IP packet is the IP multicast packet, the packet class determination unit 14 determines that the received IP packet is the IP multicast packet (step S102; YES), and executes step S104.

In step S104, the packet forwarding unit 13 of the node A determines a current network configuration based on the multihop meshed network configuration information using the network configuration determination unit 15. Then, the packet forwarding unit 13 of the node A decides a sending method based on the number of the forwarding destination nodes of the IP multicast packet using the packet sending method decision unit 16 (step S105). In the second example, because the number of the forwarding destination nodes is two, the packet sending method decision unit 16 decides the MAC-layer unicast communication (step S105; NO), and executes step S108.

In step S108, the packet forwarding unit 13 of the node A transmits the IP multicast packet from the packet transmitter 11 to the nodes B and C, respectively, by the MAC-layer unicast communication, and then, returns to step S101.

As described above, by employing the MAC-layer unicast communication on the transmission of the IP multicast packet, in the second example, it is possible to realize a communication with high tolerance for packet loss by using resending function of the MAC layer.

### /THIRD EXAMPLE

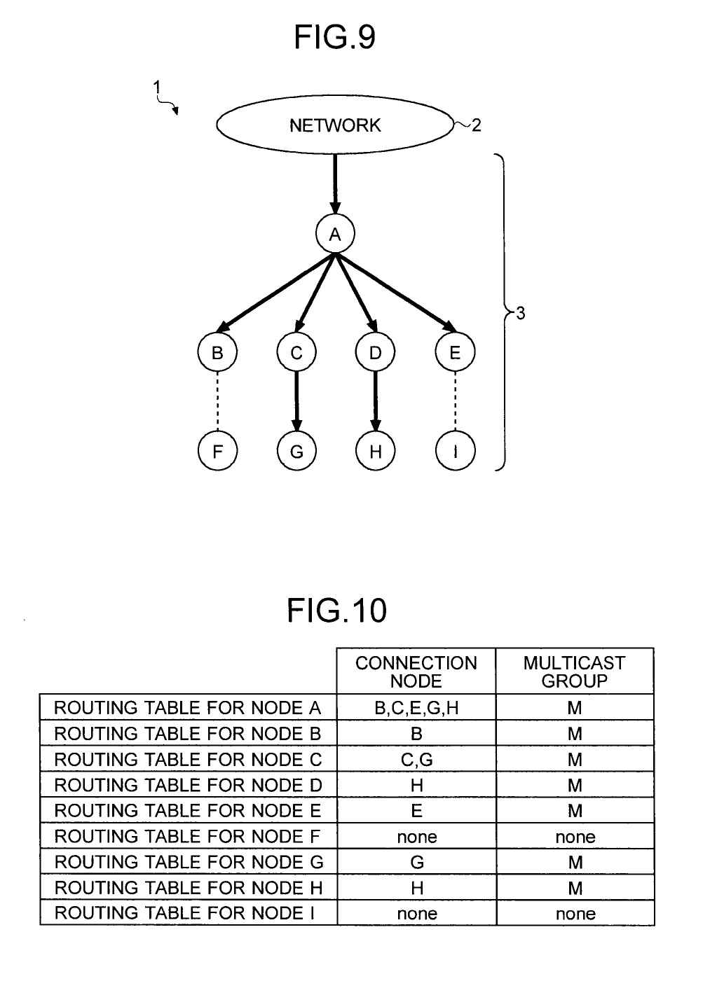

Next, as a third example, a case where the node A forwards IP multicast packet to the nodes B, C, E, G and H is explained with reference to the flow chart shown in FIG. 3. FIG. 9 is a schematic diagram for explaining the third example, and FIG. 10 is an illustration showing an IP multicast routing table stored on each node shown in FIG. 9. As the IP multicast routing table shown in FIG. 6, the routing table is created by each node based on the request for logging on the IP multicast communication using the DAO packet, and is stored on a predetermined storage. An example of the IP unicast routing table stored on each node shown in FIG. 9 may be the same as the table shown in FIG. 5.

In FIG. 9, nodes capable of IP unicast communication with the node A are the nodes B, C, D, E, F, G, H and I. The node A can directly communicate with the node B, C, D and E without hopping the other node. On the other hand, with the nodes F, G, H and I, the node A should hop the other node B, C, D or E.

The nodes B, C, E, G and H are IP multicast node capable of receiving IP multicast packet. The node A knows that the nodes B, C, E, G and H are IP multicast nodes based on the request for logging on the IP multicast communication using the DAO packet.

As shown in FIG. 10, the node A manages that the nodes B, C, E, G and H are the IP multicast nodes for receiving IP packets with a multicast address M. The nodes B, E, G and H are multicast nodes, and control receipt of IP packets with the multicast address M, respectively. The node C is a multicast node, controls receipt of IP packets with the multicast address M, and manages that the node G is a multicast node capable of receiving IP packets with the multicast address M. The node D manages that the node H is a multicast node capable of receiving IP packets with the multicast address M. The other nodes do not store IP multicast routing tables because there is no multicast node under them and they are not multicast nodes.

In the example shown in FIG. 9, the packet forwarding unit 13 of the node A waits until the packet receiver 12 receives IP packet from a communication device on the network 2 (step S101), and when the packet receiver 12 receives the IP packet (step S101; YES), the packet forwarding unit 13 determines whether the received IP packet is IP multicast packet to be forwarded or not by using the packet class determination unit 14 (step S102). In this example, because it is assumed that the received IP packet is the IP multicast packet, the packet class determination unit 14 determines that the received IP packet is the IP multicast packet (step S102; YES), and executes step S104.

In step S104, the packet forwarding unit 13 of the node A determines a current network configuration based on the multihop meshed network configuration information using the network configuration determination unit 15. Then, the packet forwarding unit 13 of the node A decides a sending method based on the number of the forwarding destination nodes of the IP multicast packet using the packet sending method decision unit 16 (step S105). In the second example, because the number of the forwarding destination nodes is four, the packet sending method decision unit 16 decides the MAC-layer broadcast communication (step S105; YES), and executes step S106.

In step S106, the packet forwarding unit 13 of the node A decides the number of repeated transmissions by the MAC-layer broadcast based on the number of the forwarding destination nodes using the packet sending method decision unit 16. The number of repeated transmissions decided in step S106 is calculated as a number which is the number of the forwarding destination nodes being incremented by one. Therefore, the packet sending method decision unit 16 calculates the number of repeated transmissions as five.

Next, the packet forwarding unit 13 of the node A repeats transmission of the IP multicast packet from the packet transmitter 11 by the MAC-layer broadcast communication 5 times according to the number of repeated transmissions decided by the packet sending decision unit 16 (step S107), and then, returns to step S101.

As described above, in the third example, by applying the MAC-layer broadcast communication to the transmission of the IP multicast packet, even if the number of forwarding destinations of the IP multicast packet is increased, it is possible to suppress the consumption of the communication band. Furthermore, by controlling the repeated transmissions of the MAC-layer broadcast, it is possible to have improved the high tolerance for packet loss at the same time.

With this embodiment, although the case where the number of repeated transmissions is calculated as the number which is the number of the forwarding destination nodes being incremented by one is explained as an example, a value to be added to the number of the forwarding destination nodes is not limited to one but can be any adjustable value. Furthermore, the calculation method is not limited to the one just described but can be any method as long as the method is capable of calculating the number of repeated transmissions that realizes high tolerance for packet loss while suppressing excessive increase in throughput of the entire network of the multihop meshed network 3.

Generally, the possibility of the number of forwarding destinations at unreceived state increasing becomes higher along with the increase of the number of the forwarding destination nodes. On the other hand, when the number of repeated transmissions is increased without limitation, the communication band may eventually be largely expended. Therefore, in order to suppress the consumption of the communication band, a limitation for the number of repeated transmissions, such as an upper limitation, for instance, can be arranged. Furthermore, in order to prevent the number of unreceived forwarding destinations from increasing, a limitation for the number of repeated transmissions, such as a lower limitation, for instance, can be arranged.

With this embodiment, the case where the sending method is decided based on the number of forwarding destination nodes is described as an example. However, the sending method can be decided based on the number of IP multicast nodes on the whole multihop meshed network 3, for instance. For example, in the RPL, each node manages the number of all the IP multicast network nodes located downstream from oneself (hereinafter to be referred to as downstream nodes) by receiving DAO packets transmitted from the downstream nodes. The packet sending method decision unit 16, by using such behavior, may calculate the number of the IP multicast nodes and decide the sending method of IP multicast packet based on the calculated number of the IP multicast nodes. Because this method can prevent a situation where a plurality of non-receiving nodes occur due to upstream packet loss, this method is especially effective for a case with a small number of forwarding destination nodes and a large number of IP multicast nodes.

Likewise, in the embodiment, although the case where the number of repeated transmissions is calculated based on the number of the forwarding destination nodes is described as an example, the number of repeated transmissions can be calculated based on the number of downstream nodes. Because this method also can prevent a situation where a plurality of non-receiving nodes occur due to upstream packet loss, this method is especially effective for a case with a small number of forwarding destination nodes and a large number of IP multicast nodes.

As described above, according to the embodiment, in the multihop meshed network 3, it is possible to realize a multicast communication with high reliability while suppressing the consumption of the communication band. For example, in a congested configuration with a large number of adjacent nodes, it is possible to maintain the reliability of the communication while using the MAC-layer broadcast communication capable of suppressing throughput. On the other hand, in a sparse configuration with a small number of adjacent nodes, it is possible to maintain the reliability required by each forwarding destination while using the MAC-layer unicast communication.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device which is connected with other communication device via a multihop meshed network, the device comprising:
a transmission unit configured to transmit packet to the other communication device by either one of a unicast communication and a multicast communication; and
a decision unit configured to decide between the unicast communication and the multicast communication as a sending method of multicast packet to be transmitted form the transmission unit based on configuration information about the multihop meshed network.

2. The device according to claim 1, further comprising:
a receiver configured to receive packet via a network; and
a class determination unit configured to determine whether the packet received by the receiver is unicast packet or multicast packet,
the decision unit, when the packet received by the receiver is the multicast packet, deciding between the unicast communication and the multicast communication as the sending method of the multicast packet based on the configuration information.

3. The device according to claim 1, wherein the configuration information includes the number of other communication devices being forwarding destinations of the multicast packet.

4. The device according to claim 1, wherein the configuration information includes the number of other communication devices being receipt targets of the multicast packet.

5. The device according to claim 1, wherein the configuration information includes both of the number of other communication devices being forwarding destinations of the multicast packet and the number of other communication devices being receipt targets of the multicast packet.

6. The device according to claim 1, wherein the multicast communication is a broadcast communication.

7. The device according to claim 1, wherein
the decision unit decides the number of repeated transmissions of the multicast packet based on the configuration information, and
the transmission unit repeats transmission of the multicast packet according to the number of repeated transmissions decided by the decision unit.

8. The device according to claim 1, further comprising a configuration determination unit configured to acquire the configuration information about the multihop meshed network.

9. The device according to claim 8, wherein the configuration determination unit acquires the configuration information based on requests for logging on the multicast communication received from the other communication devices connected to the multihop meshed network.

10. A method of communication control of a communication device connected with other communication devices via a multihop meshed network, the method including:
deciding between a unicast communication and a multicast communication as a sending method of multicast packet based on configuration information about the multihop meshed network; and
transmitting the multicast packet to the other communication devices according to the decided sending method.

11. A non-transitory computer readable medium including a program for operating a computer of a communication device connected with other communication devices via a multihop meshed network, the program including the instructions of:
deciding between a unicast communication and a multicast communication as a sending method of multicast packet based on configuration information about the multihop meshed network; and
transmitting the multicast packet to the other communication devices according to the decided sending method.
